(19) United States
(12) Patent Application Publication
(10) Pub. No.: US 2005/0272489 A1
(43) Pub. Date: Dec. 8, 2005

(54) Strap with antenna and battery power

(76) Inventor: Steven K. Lee, Edina, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 10/848,676

(22) Filed: May 19, 2004

(51) Int. Cl. H04M 1/00

(52) U.S. Cl. 455/575.7

(57) ABSTRACT

A carrying strap is presented that contains a battery and an antenna. The strap is physically connected to an electronic device for the purpose of carrying the device. The battery and antenna are electrically connected to the device to allow the device to use the antenna signal and the battery power from the strap.

### TECHNICAL FIELD

The present invention relates to a portable electronic device carrying strap containing battery power and an antenna mechanism for use by the portable electronic device.

### BACKGROUND OF THE INVENTION

More and more electronic devices are capable of communicating with other electronic devices through a wireless network. For instance, computers can communicate with other computers over a wireless local area network such as defined by one of the 802.11 standards (sometimes called “WiFi”). In addition, computers and personal digital assistants (PDAs) are able to communicate with the Internet through various 3G networks operated by wireless telephone companies, such as Sprint PCS (Kansas City, Mo.) and Verizon Wireless (Bedminster, N.J.).

Unfortunately, mobile devices such as portable computers and PDAs suffer from two major shortcomings when used to access these wireless networks, namely poor reception and short battery life. The poor reception generally is caused by the fact that it is often impractical to imbed an ideal antenna within the cases of a personal device. PDAs are generally small enough to be held within the hand, and therefore have little room for a large antenna. Similarly, even where an antenna is designed into a portable computer from the start, the size and shape of the computer limit the reception and transmission ability of the antenna. The same physical size restrictions limit the battery power that can be stored within a device, particularly when weight is a major design concern. What is needed is a way to increase the antenna ability and battery power of a portable device without altering the weight and size limitations inherent in a portable device design.

### SUMMARY OF THE INVENTION

The present invention meets this need by providing a carrying strap containing batteries and an antenna. These components would preferably be on the interior of the strap, thereby given the strap a traditional external appearance. The strap is attached to the portable device at the ends of the strap using a physical connection mechanism. In addition to the physical connection mechanism, electrical connectors are provided at one or both ends of the strap to allow the portable device to draw power from the batteries contained in the strap and to connect an internal antenna lead to the antenna found within the strap. Alternatively, the strap could attach to a base platform that could be connected to the portable device. Electrical leads coming from the base platform or directly from the strap would then connect the strap's internal battery and antenna to the portable device. The strap could also attach to the portable device through the use of a size-adjustable wire or bar, around which the portable device could be secured. In this case, the electrical leads would extend directly from the strap.

### BRIEF DESCRIPTION OF THE DRAWINGS

FIG. 1 is a cross-sectional view of the strap of the present invention along with an associated portable device.

FIG. 2 is an isometric view of a base platform that could be attached to a portable device and then connected to the strap of FIG. 1.

FIG. 3 is a cross-sectional view of an alternative version of the present invention strap utilizing a size-adjustable wire.

### DETAILED DESCRIPTION OF THE INVENTION

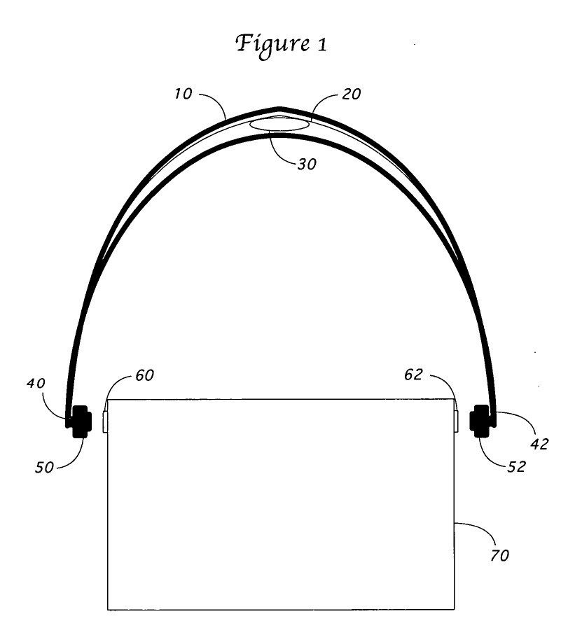

A strap of the present invention is shown in FIG. 1. The strap (or “strap body”) 10 carries within it an antenna 20 and a battery 30. The antenna 20 is shown as a wire antenna running from a first end 40 of the strap 10 to a second end 42 of the strap 10. The length, shape, and composition of the antenna 20 would be determined according to known antenna theory and the characteristics of the wireless network to be used by the present invention.

Connectors 50, 52 are attached to each end 40, 42 of the strap, respectively. These connectors 50-52 are designed to form a physical connection with the matching connectors 60-62 that are found on a portable electronic device 70. When the two sets of connectors 50-52, 60-62 are connected, the strap 10 is held physically in place, thereby securing the strap 10 to the portable device 70.

In the preferred embodiment as shown in FIG. 1, the connectors 50, 52, 60, 62 serve a dual purpose: creating a secure physical connection and providing an electrical connection between the strap 10 and the portable device 70. In this preferred embodiment, the antenna 20 and the battery 30 are connected to either or both of the strap connectors 50-52. Electrical conduits within at least one of the strap connectors 50-52 then make contact with electrical conduits within the corresponding device connector 60-62, thereby putting the device 70 in electrical communication with the antenna 20 and the battery 30 within strap 10. One example connector 50-62 that could be used to perform this dual physical/electrical function is the well-known BNC (bayonet) connector.

The battery 30 can be composed of one or more battery cells, and is designed specifically to provide power to the portable electronic device 70. It would be an easy matter to provide conversion circuitry within the strap 10 so as to change the voltage provided by the strap 10 to meet the needs of multiple electronic devices 70.

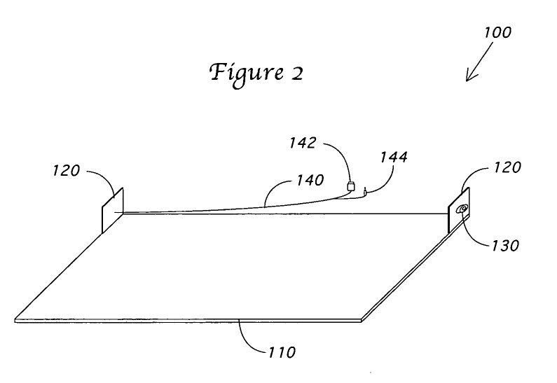

The preferred embodiment shown in FIG. 1 requires that the device 70 have connectors 60-62 built into the device to receive the strap connectors 50-52 and make connection to the antenna 20 and the battery 30. An alternative to requiring the device 70 to conform to the strap 10 is to use a base platform 100 such as that shown in FIG. 2. The base platform 100 has a sheet component 110 that preferably provides a flat surface on which a portable device can rest and be secured. Any known methods for attaching the device to the sheet 110 can be used, such as straps, hook and loop tape, clips, etc. (not shown). The base platform 100 preferably has two tabs 120 extending from the sheet 110, with each tab 120 having a connector 130 (only one shown in FIG. 2) for making a physical connection with the strap connectors 50-52. The base platform 100 further includes electrical leads 140 for making an electrical connection with the device. In FIG. 2, electrical lead 140 is shown with two connectors 142, 144, thereby providing a separate battery connector 142 and antenna connector 144. In the platform 100 shown in FIG. 2, the lead 140 is connected to one of the platform connectors 130. When the strap connectors 50-52 are connected to the platform connectors 130, the lead 140 will be in communication with the antenna 20 and battery 30 within the strap 10. While FIG. 2 shows the lead 140 with two connection components 142, 144, it is well within the scope of the present invention to use a single component carrying both the antenna signal and battery power. It is also feasible that the platform would use two separate electrical leads 140, one for each connector 142, 144. These leads 140 could come from a single connector 130 or one lead 140 may come from each connector 130.

The sheet 110 can be a rigid sheet of a fixed size. In this case, the sheet would be sized to fit the known shape and size of a portable computer or a PDA. Alternatively, it is known in the prior art to create sheets 110 of multiple parts that slide together, thereby allowing the sheet 110 to be of a variable size so as to fit multiple brands and models of PDAs and portable computers. Especially where the sheet 110 is of a variable size, it is possible to use the sheet 110 and tabs 120 themselves to hold the electronic device to the platform 100 by adjusting the size of the sheet 110 so as to snugly hold the device between tabs 120. Alternatively, separate adjustable tabs could be placed on the sheet 110 to hold the device.

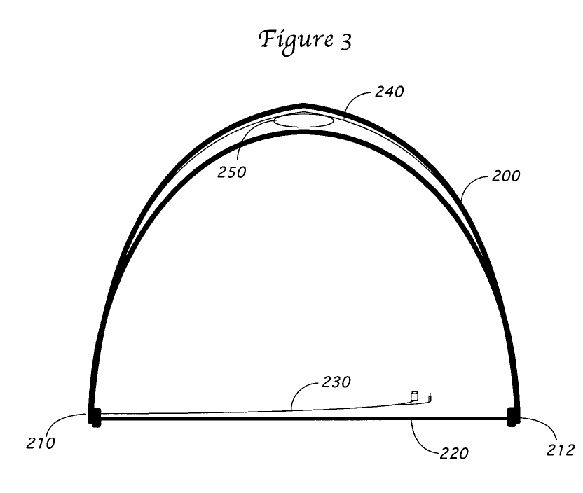

An alternative strap design 200 is shown in FIG. 3. This strap 200 lacks the physical connectors at its ends 210, 212. Instead, the strap 200 utilizes a wire or bar 220 extending from one end 210 to the other 212. A portable electronic device (not shown) could then be secured to the strap 200 by closing the device around the wire or bar 220. In the preferred embodiment, this wire or bar 220 would be of an adjustable size so as to fit the device carried by the strap 220. Of course, it would be well within the scope of the present invention to use a fixed-size wire or strap 220. The strap 200 further has an electrical lead 230 for connecting the antenna 240 and battery 250 found within the strap 200 to the electrical device.

The electrical lead 230 coming directly from the strap could also be utilized in the embodiment shown in FIG. 1. In this case, the strap connectors 50-52 would provide only a physical connection to the device 70, while using the electrical lead 230 to form the electrical connection. Once the connectors 50-52 no longer need to make an electrical connection as well as a physical connection, it is possible to simplify these connectors. For instance, the physical connectors could be simple hooks, snaps, carabiners, or clips that connect to mating connectors such as rings or bars. A strap connected lead 230 could also be used in conjunction with platform 100 of FIG. 2. This would eliminate the need for lead 140 that attaches to the platform 100 itself.

Many possible combinations of features and elements are possible within the scope of the present invention. Consequently, the scope of the present invention is not to be limited to the above description, but rather is to be limited only by the following claims.

1. A strap for carrying an electronic device comprising:
a) a strap body;
b) a battery found within the strap body;
c) an antenna found within the strap body;
d) at least one electrical connector for connecting the battery and the antenna to the electronic device; and
e) a physical connector for physically securing the strap body to the electronic device.

2. The strap of claim 2, wherein the electrical connector is formed integral to the physical connector.

3. The strap of claim 3, wherein a BNC connector is used as the physical connector and the electrical connector.

4. The strap of claim 1, wherein the physical connector takes the form of an adjustable bar extending from a first end of the strap body to a second end of the strap body.

5. The strap of claim 5, wherein the electrical connector takes the form of a electric lead extending from one of the ends of the strap body.

6. The strap of claim 1, wherein the electrical connector takes the form of a electric lead extending from one of the ends of the strap body.

7. The strap of claim 6, wherein the physical connector utilizes a mechanism selected from the group consisting of hooks, snaps, carabiners, and clips.

8. A strap for carrying an electronic device comprising:
a) a strap body containing a battery and an antenna;
b) battery connection means for connecting the battery to the electronic device;
c) antenna connection means for connecting the antenna to the electronic device; and
d) physical connection means for physically securing the strap body to the electronic device.

9. A system for attaching external battery power and an antenna to a portable electronic device comprising:
a) a strap having
i) a strap body containing a battery and an antenna,
ii) a physical connector,
iii) a power connector in electrical communication with the battery, and
iv) an antenna connector in electrical communication with the antenna; and
b) a platform that is separable from the electronic device having
i) a strap connector secured to the physical connector, and
ii) a device connector secured to the electronic device.

10. The system of claim 9, wherein the platform further comprises
iii) a first connector electrically connected to the antenna connector;
iv) a second connector electrically connected to the power connector;
v) a lead electrically connected to the electronic device,

11. The system of claim 10, wherein the lead is electrically connected to both the first and second connectors.

12. The system of claim 9, wherein the power connector and the antenna connector both connect directly to the electronic device without connecting to the platform.

13. The system of claim 9, further comprising a sheet upon which the electronic device can rest.

14. The system of claim 13, wherein the size of the sheet is adjustable.

15. The system of claim 9, wherein the device connector is a plurality of tabs, at least one of which is adjustable.

16. The system of claim 9, wherein the device connector is hook and loop tape.
